(19) United States
(12) Patent Application Publication
(10) Pub. No.: US 2022/0189655 A1
(43) Pub. Date: Jun. 16, 2022

(54) WIRE HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Yuta KITAHARA, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 17/438,267

(22) PCT Filed: Jan. 27, 2020
(86) PCT No.: PCT/JP2020/002791

§ 371 Date: Sep. 10, 2021

(30) Foreign Application Priority Data
Mar. 11, 2019 (JP) 2019-043639

(51) Int. Cl. H01B 7/00; H01B 7/18; H01B 7/20; B60R 16/02

(52) U.S. Cl. CPC H01B 7/0045; B60R 16/0215; H01B 7/20; H01B 7/184

(57) ABSTRACT

A wire harness including: a plurality of electric wires; a cylindrical protective tube that collectively houses the plurality of electric wires; a restricting member that is provided within the protective tube and includes a housing space through which the plurality of electric wires are passed and that is shaped and sized to restrict an arrangement direction of the plurality of electric wires to a specific direction; a plurality of grooves that are formed in an inner circumferential surface of the protective tube at a predetermined spacing in a circumferential direction of the protective tube; and a protrusion that is formed on an outer circumferential surface of the restricting member and is fitted into one groove of the plurality of grooves.

### BACKGROUND

The present disclosure relates to a wire harness.

Conventionally, a wire harness for use in a vehicle such as a hybrid vehicle or an electric automobile includes electric wires that electrically connect electric devices such as a high-voltage battery and an inverter (see, for example, JP 2016-58137A). In the wire harness, the plurality of electric wires are collectively covered by a metal pipe, for the purpose of protecting the electric wires and reducing noise.

### SUMMARY

However, in the wire harness described above, bending processing is performed on the metal pipe with the plurality of electric wires passed through the metal pipe. Due to the bending processing, as shown in FIG. 9, electric wires 90 that are passed through a metal pipe 80 are also bent together with the metal pipe 80. As a result, the electric wires 90 come into contact with the inner circumferential surface of the metal pipe 80 on a bent inner side 81A of a bent portion 81 of the metal pipe 80. At this time, a situation may occur in which the plurality of electric wires 90 are arranged overlapping each other on the bent inner side 81A, as a result of which, the innermost one of the plurality of electric wires 90 comes into contact with the inner circumferential surface of the bent inner side 81A of the bent portion 81 of the metal pipe 80, and the outermost one of the plurality of electric wires 90 that is close to the outer side of the bent portion 81 overlaps the innermost electric wire from the outer side and presses the innermost electric wire toward the inner circumferential surface of the bent inner side 81A of the bent portion 81 of the metal pipe 80. In this case, as shown in FIG. 10, a pressing force that presses an outer circumferential surface of each electric wire 90 against the inner circumferential surface of the metal pipe 80 on the bent inner side 81A is increased. That is, the outer circumferential surface of the innermost electric wire 90 comes into contact with the inner circumferential surface of the bent inner side 81A, with the plurality of electric wires 90 being arranged overlapping each other, and thus the pressing force of the plurality of electric wires 90 acts on a contact portion between the outer circumferential surface of the innermost electric wire 90 and the inner circumferential surface of the metal pipe 80 (see the arrows shown in FIG. 10). As a result, at the contact portion between the outer circumferential surface of the innermost electric wire 90 and the inner circumferential surface of the metal pipe 80, a problem may occur in which the thickness of the insulation coating 91 of the electric wire 90 is reduced, which diminishes the insulation reliability of the electric wire 90.

An exemplary aspect of the disclosure provides a wire harness in which a reduction in the insulation reliability can be suppressed.

A wire harness according to the present disclosure includes: a plurality of electric wires; a cylindrical protective tube that collectively houses the plurality of electric wires; a restricting member that is provided within the protective tube and includes a housing space through which the plurality of electric wires are passed and that is shaped and sized to restrict an arrangement direction of the plurality of electric wires to a specific direction; a plurality of grooves that are formed in an inner circumferential surface of the protective tube at a predetermined spacing in a circumferential direction of the protective tube; and a protrusion that is formed on an outer circumferential surface of the restricting member and is fitted into one groove of the plurality of grooves.

The wire harness according to the present disclosure provides the effect of suppressing a reduction in the insulation reliability.

### BRIEF DESCRIPTION OF THE DRAWINGS

FIG. 1 is a schematic side view of a wire harness according to one embodiment.

FIG. 2 is a schematic horizontal cross-sectional view of the wire harness according to one embodiment (a cross-sectional view taken along the line 2-2 shown in FIG. 1).

FIG. 3 is a schematic horizontal cross-sectional view of the wire harness according to one embodiment (a cross-sectional view taken along the line 3-3 shown in FIG. 1).

FIG. 4 is a schematic horizontal cross-sectional view of the wire harness according to one embodiment (a cross-sectional view taken along the line 4-4 shown in FIG. 1).

FIG. 5 is a schematic cross-sectional view of the wire harness according to one embodiment.

FIG. 6 is a schematic perspective view of the wire harness according to one embodiment.

FIGS. 7(a) to 7(c) are schematic perspective views illustrating a method for producing a wire harness according to one embodiment.

FIG. 8 is a schematic horizontal cross-sectional view of a wire harness according to a variation.

FIG. 9 is a schematic side view of a conventional wire harness.

FIG. 10 is a schematic horizontal cross-sectional view of the conventional wire harness (a cross-sectional view taken along the line 10-10 shown in FIG. 9).

### DETAILED DESCRIPTION OF EMBODIMENTS

A specific example of the wire harness according to the present disclosure will be described below with reference to the drawings. In the accompanying drawings, some constituent elements may be shown enlarged or simplified for the sake of ease of understanding. Also, the scaling factor of the constituent elements may vary from diagram to diagram. It is to be noted that the present disclosure is not limited to examples given below, the scope of the present disclosure is indicated by the appended claims, and all changes that come within the meaning and range of equivalency of the claims are intended to be embraced within the scope of the present disclosure.

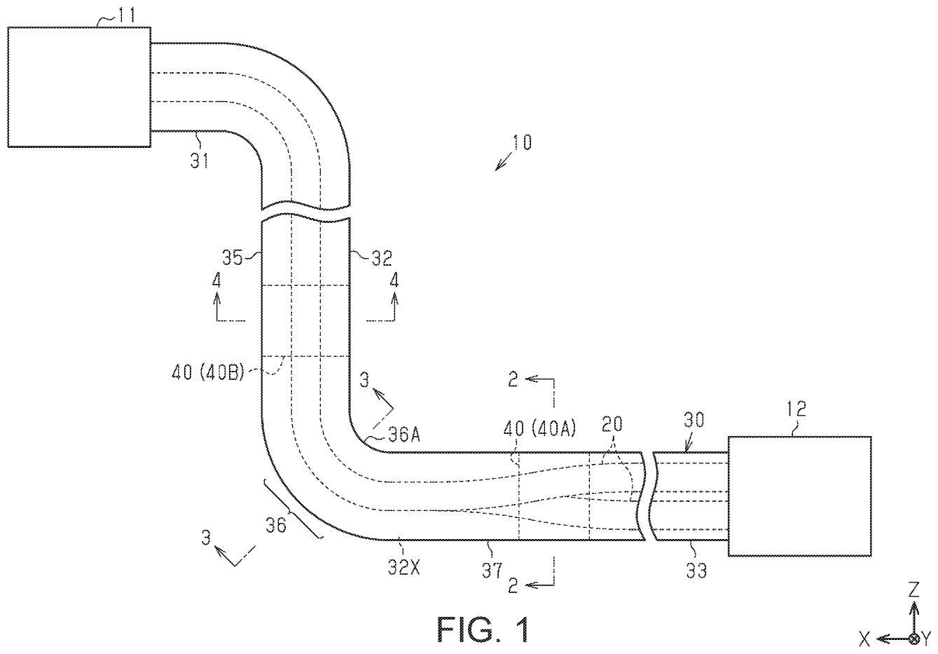

A wire harness 10 shown in FIG. 1 electrically connects two, three or more electric devices (devices). The wire harness 10 electrically connects, for example, an inverter 11 and a high-voltage battery 12, the inverter 11 being provided in a front portion of a vehicle such as a hybrid vehicle or an electric automobile, and the high-voltage battery 12 being provided in a rear portion of the vehicle relative to the inverter 11. The wire harness 10 is routed, for example, under the floor of the vehicle or the like. The inverter 11 is connected to a motor (not shown) that is for driving wheels and serves as a power source for driving the vehicle. The inverter 11 generates alternating current power from the direct current power of the high-voltage battery 12, and supplies the generated alternating current power to the motor. The high-voltage battery 12 is a battery that can supply, for example, a voltage of several hundred volts.

In the description given below, the left-right direction in FIG. 1 will be referred to as “the front-rear direction X of the vehicle”, a direction perpendicular to the plane of FIG. 1 will be referred to as “the width direction Y of the vehicle”, and the up-down direction in FIG. 1 will be referred to as “the up-down direction Z of the vehicle”.

The wire harness 10 includes a plurality of (two in the present embodiment) electric wires 20 and an external member 30 that surrounds the electric wires 20. One end portion of each electric wire 20 is connected to the inverter 11, and the other end portion of each electric wire 20 is connected to the high-voltage battery 12. The electric wires 20 are bent into, for example, a two-dimensional shape or a three-dimensional shape. For example, the electric wires 20 are bent into a predetermined shape according to the routing path of the wire harness 10. The electric wires 20 are, for example, high-voltage electric wires that can support high voltages and large currents. The electric wires 20 may be, for example, unshielded electric wires that do not have an electromagnetic shielding structure or shielded electric wires that have an electromagnetic shielding structure. The electric wires 20 of the present embodiment are unshielded electric wires.

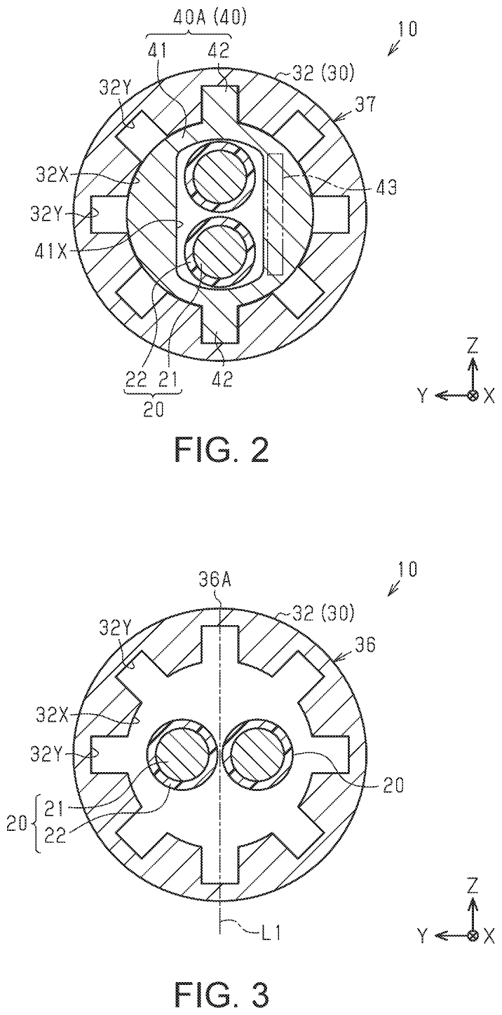

As shown in FIGS. 2 and 3, each electric wire 20 includes a core wire 21 composed of a conductor and an insulation coating 22 that covers an outer circumference of the core wire 21. As the core wire 21, for example, a twisted wire composed of a plurality of metal strands that are twisted together, a columnar conductor (a single core wire, a bus bar, or the like) composed of a columnar metal rod that has a solid structure, a cylindrical conductor (a pipe conductor) that has a hollow structure, or the like can be used. Alternatively, as the core wire 21, a combination of twisted wires, columnar conductors, or cylindrical conductors may be used. The core wire 21 of the present embodiment is a single core wire. As the material of the core wire 21, for example, a metal material such as a copper-based metal material or an aluminum-based metal material can be used. The core wire 21 is formed through extrusion molding, for example.

The cross section of the core wire 21 may have any shape, the cross section being obtained by cutting the core wire 21 along a plane perpendicular to the lengthwise direction of the core wire 21. That is, the horizontal cross-section of the core wire 21 may have any shape. The horizontal cross-section of the core wire 21 may have, for example, a circular shape, a semicircular shape, a polygonal shape, a square shape, or a flat shape. In the specification of the present application, the term “flat shape” may refer to a shape that has short sides or minor axes and long sides or major axes and has an aspect ratio other than 1. The term “flat shape” encompasses, for example, a rectangular shape, an oval shape, an elliptical shape, and the like. The term “rectangular shape” used in the specification of the present application refers to a shape that has long sides and short sides, and excludes a square shape. The term “rectangular shape” used in the specification of the present application also encompasses a shape with chamfered corners and a shape with rounded corners. The horizontal cross-section of the core wire 21 of the present embodiment has a circular shape.

The insulation coating 22 covers, for example, the entire outer circumferential surface of the core wire 21 in an intimate contact manner. The insulation coating 22 is made of an insulating material such as a synthetic resin. The insulation coating 22 can be formed by, for example, performing extrusion molding (extrusion coating) on the core wire 21.

The external member 30 has an overall elongated cylindrical shape. The plurality of electric wires 20 are passed through an internal space of the external member 30. The external member 30 is formed so as to surround all outer circumferences of the plurality of electric wires 20. The external member 30 protects the electric wires 20 that are housed in the external member 30 from projectiles and water droplets. As the external member 30, for example, a pipe made of metal or resin, a protector made of resin, a flexible corrugated tube made of resin or the like, a water-resistant cover made of rubber, or a combination thereof can be used.

As shown in FIG. 1, the external member 30 includes a corrugated tube 31, a metal pipe 32, and a corrugated tube 33. The corrugated tube 31 is provided so as to, for example, cover end portions of the electric wires 20 that are on the inverter 11 side. The corrugated tube 33 is provided so as to, for example, cover end portions of the electric wires 20 that are on the high-voltage battery 12 side. The metal pipe 32 is provided so as to cover the electric wires 20 between the corrugated tube 31 and the corrugated tube 33. As the material of the corrugated tubes 31 and 33, for example, a conductive resin material or a non-conductive resin material can be used. As the resin material, for example, a synthetic resin such as polyolefin, polyamide, polyester, or ABS resin can be used. As the material of the metal pipe 32, a metal material such as a copper-based metal material, an iron-based metal material, or an aluminum-based metal material can be used. The metal pipe 32 has, in addition to a protective function for protecting the electric wires 20 from projectiles, and the like, an electromagnetic shielding function for protecting the plurality of electric wires 20 from electromagnetic waves.

The metal pipe 32 has an overall elongated cylindrical shape. The metal pipe 32 of the present embodiment includes a linear portion 35 that extends linearly along the up-down direction Z of the vehicle at an end portion that is on the corrugated tube 31 side, a bent portion 36 that is formed at one end portion of the linear portion 35, and a linear portion 37 that extends linearly from the bent portion 36 in the front-rear direction X of the vehicle. The bent portion 36 includes a bent inner side 36A.

As shown in FIGS. 2 to 4, the metal pipe 32 includes an internal space 32X. In the internal space 32X of the metal pipe 32, the plurality of electric wires 20 are provided side by side. The metal pipe 32 of the present embodiment has a cylindrical shape. That is, the metal pipe 32 is configured such that the inner circumference and the outer circumference of the metal pipe 32 have a circular cross section as a whole. The internal space 32X of the metal pipe 32 has, for example, a circular horizontal cross section.

In an inner circumferential surface of the metal pipe 32, a plurality of (eight in this example) groove portions 32Y (grooves) are formed recessed from the inner circumferential surface of the metal pipe 32 toward the outside of the metal pipe 32 in the radial direction. The plurality of groove portions 32Y are provided at a predetermined spacing in the circumferential direction of the metal pipe 32. The plurality of groove portions 32Y are formed, for example, extending radially approximately the central axis of the metal pipe 32 in the radial direction. The plurality of groove portions 32Y are provided, for example, equidistantly in the circumferential direction of the metal pipe 32. The plurality of groove portions 32Y are formed, for example, over the entire circumferential direction of the inner circumferential surface of the metal pipe 32. The eight groove portions 32Y of the present embodiment are provided at positions at intervals of 45 degrees in the circumferential direction of the metal pipe 32. The groove portions 32Y are formed so as to, for example, expand the internal space 32X radially outward. Each groove portion 32Y is formed extending over the entire length of the metal pipe 32 in the lengthwise direction of the metal pipe 32. Each groove portion 32Y can have a horizontal cross section of any shape. The horizontal cross section of each groove portion 32Y may have, for example, a semicircular shape, a polygonal shape, or a flat shape. Each groove portion 32Y of the present embodiment has a rectangular horizontal cross section.

Here, the metal pipe 32 is formed through extrusion molding, for example. The metal pipe 32 described above is formed so as to have, for example, a horizontal cross section with a predetermined shape over the entire length of the metal pipe 32 in the length direction.

In the wire harness 10 shown in FIG. 1, the plurality of electric wires 20 are disposed within the metal pipe 32 such that the plurality of electric wires 20 are positioned side by side relative to the bent inner side 36A of the bent portion 36. In other words, in the wire harness 10, the plurality of electric wires 20 are disposed within the metal pipe 32 such that the plurality of electric wires 20 do not overlap a straight line that extends from the bent inner side 36A in the radial direction of the metal pipe 32.

The wire harness 10 includes one or more (two in this example) restricting members 40 that restrict the positions of the plurality of electric wires 20 within the metal pipe 32. The plurality of restricting members 40 are provided, for example, spaced apart from each other in the lengthwise direction of the metal pipe 32. The restricting members 40 are provided, for example, at an intermediate portion of the metal pipe 32 in the lengthwise direction of the metal pipe 32. The restricting members 40 are provided only in, for example, the linear portions 35 and 37 out of the linear portions 35 and 37 and the bent portion 36 of the metal pipe 32. In other words, a restricting member 40 is not provided in the bent portion 36. The restricting members 40 are respectively provided in, for example, regions of the linear portions 35 and 37 near the bent portion 36.

As shown in FIG. 2, each restricting member 40 includes a cylindrical main body portion 41. The main body portion 41 is shaped to be capable of being fitted into the internal space 32X of the metal pipe 32. The main body portion 41 is formed such that the outer circumference of the main body portion 41 has a cross-sectional shape corresponding to the cross-sectional shape of the inner circumference of the metal pipe 32. The outer circumference of the main body portion 41 of the present embodiment has a circular cross section. The outer diameter of the main body portion 41 is set to be, for example, slightly smaller than the inner diameter of the metal pipe 32. In a state in which the restricting members 40 are housed in the internal space 32X of the metal pipe 32, for example, at least a portion of the outer circumferential surface of the main body portion 41 is in contact with the inner circumferential surface of the metal pipe 32.

As shown in FIG. 5, the main body portion 41 is formed, for example, extending in the lengthwise direction of the metal pipe 32. The lengthwise direction of the main body portion 41 extends in a direction that matches, for example, the lengthwise direction of the metal pipe 32. In a center portion of the main body portion 41, a housing space 41X that extends in the lengthwise direction is formed.

As shown in FIG. 2, the housing space 41X is formed so as to, for example, allow the plurality of electric wires 20 to be collectively passed therethrough. The housing space 41X is sized to be capable of restricting the arrangement direction (alignment direction) of the plurality of electric wires 20 to a specific direction. The housing space 41X of the present embodiment is sized to be capable of restricting, for example, the arrangement direction of the plurality of electric wires 20 in a horizontal cross section to one direction. The housing space 41X has, for example, a flat horizontal cross section. The housing space 41X of the present embodiment has an oval-shaped horizontal cross section. That is, the inner circumference of the housing space 41X has an oval cross section. In other words, the housing space 41X of the present embodiment has an elongated cylindrical shape. Here, the term “oval shape” used in the specification of the present application refers to a shape that includes two parallel lines that have a substantially equal length and two arc portions that connect the end portions of the two parallel lines. In the specification of the present application, in the oval shape, an axis that passes through the center of the oval shape and extends in parallel to the two parallel lines is referred to as the “major axis”, and an axis that passes through the center of the oval shape and extends in a direction perpendicular to the major axis is referred to as the “minor axis”. A direction in which the major axis extends is referred to as a “major axis direction”, and a direction in which the minor axis extends is referred to as a “minor axis direction”.

In the housing space 41X, a length dimension that extends along the major axis and a length dimension that extends along the minor axis are set such that, for example, the plurality of electric wires 20 can be arranged side by side in the major axis direction, and cannot be arranged side by side in the minor axis direction.

One or more protruding portions 42 (protrusions) that can be fitted into one or more groove portions 32Y of the metal pipe 32 are formed on the outer circumferential surface of the main body portion 41. The protruding portions 42 are formed protruding from the outer circumferential surface of the main body portion 41 toward the outside of the main body portion 41 in the radial direction. The protruding portions 42 are formed continuously from, for example, the main body portion 41 as a single piece. The number of protruding portions 42 is set to be less than or equal to the number of groove portions 32Y of the metal pipe 32. In the present embodiment, two protruding portions 42 are formed on the outer circumferential surface of the main body portion 41.

The plurality of protruding portions 42 are provided at positions spaced apart from each other in the circumferential direction of the main body portion 41. The plurality of protruding portions 42 are provided, for example, at such positions that all of the plurality of protruding portions 42 can be fitted into the groove portions 32Y of the metal pipe 32. In the present embodiment, two protruding portions 42 are positioned approximately 180 degrees apart from each other in the circumferential direction of the main body portion 41. The two protruding portions 42 are provided on, for example, on an extension line of the major axis of the housing space 41X.

The horizontal cross section of each protruding portion 42 is shaped and sized to be capable of being fitted into a groove portion 32Y of the metal pipe 32. The horizontal cross section of each protruding portion 42 of the present embodiment has a rectangular shape that corresponds to the shape of the horizontal cross section of each groove portion 32Y. The size of the horizontal cross section of each protruding portion 42 is slightly smaller than the size of the horizontal cross section of each groove portion 32Y. In a state in which the protruding portion 42 is fitted into the groove portion 32Y, for example, at least a portion of the outer circumferential surface of the protruding portion 42 is in contact with the inner circumferential surface of the groove portion 32Y. Each protruding portion 42 is formed, for example, extending over the entire length of the main body portion 41 in the lengthwise direction.

As shown in FIG. 5, a holding piece 43 protruding from an end face of the main body portion 41 in the lengthwise direction is formed on an end face of the main body portion 41 in the lengthwise direction. The holding piece 43 is formed protruding in a direction away from the housing space 41X. The holding piece 43 is formed protruding in a direction in which the plurality of electric wires 20 that are drawn out from the housing space 41X extend. The holding piece 43 has, for example, a flat plate shape. The holding piece 43 is formed continuously from, for example, the main body portion 41 as one piece. The restricting member 40 of the present embodiment is a single component in which the main body portion 41, the protruding portion 42, and the holding piece 43 are unitarily formed.

As shown in FIG. 2, the holding piece 43 is provided, for example, extending along the housing space 41X. The holding piece 43 can have, for example, a horizontal cross section of any shape. The horizontal cross section of the holding piece 43 of the present embodiment has a rectangular shape that includes long sides that extend in a direction parallel to the major axis direction of the housing space 41X and short sides that extend in a direction parallel to the minor axis direction of the housing space 41X.

As shown in FIG. 5, tape 50 is used to fix the holding piece 43 to the plurality of electric wires 20 that are drawn out from the housing space 41X. In other words, the tape 50 is spirally wound around the holding piece 43 together with the plurality of electric wires 20 that are drawn out from the housing space 41X, and the plurality of electric wires 20 are thereby held by the holding piece 43. As a result, the position of the restricting member 40 in the lengthwise direction of the plurality of electric wires 20 can be fixed.

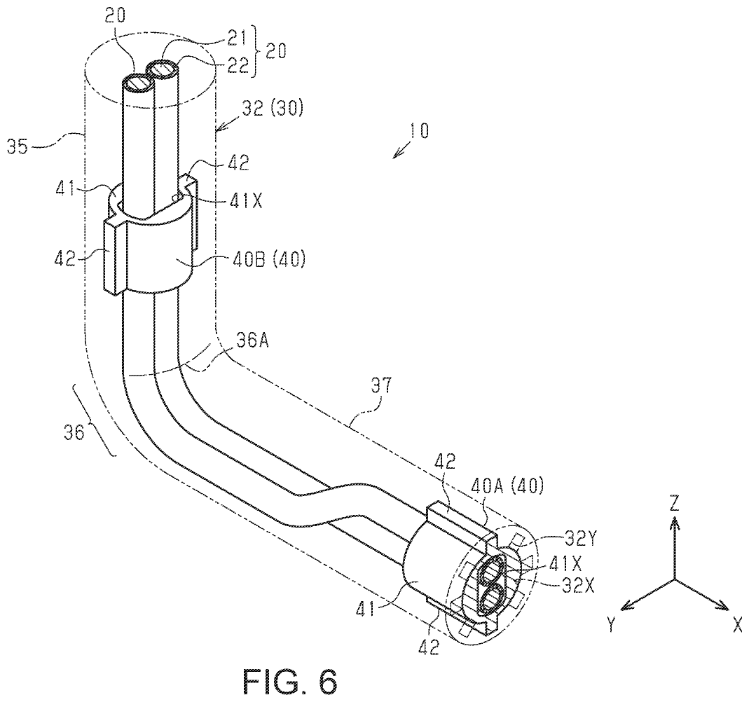

As shown in FIG. 6, the plurality of restricting members 40 includes a restricting member 40A that is provided in the linear portion 37 and a restricting member 40B that is provided in the linear portion 35. The bent portion 36 of the metal pipe 32 is disposed between the restricting member 40A and the restricting member 40B. In the restricting members 40A and 40B, the angles of rotation of the restricting members 40A and 40B are adjusted such that the major axis direction of the housing space 41X of the restricting member 40A and the major axis direction of the housing space 41X of the restricting member 40B are different from each other by relatively rotating the restricting members 40A and 40B. In doing so, the positions of the plurality of electric wires 20 are restricted such that the plurality of electric wires 20 are positioned side by side relative to the bent inner side 36A of the bent portion 36 of the metal pipe 32. This will be described in detail below with reference to FIGS. 2 to 4 and FIG. 6. In FIG. 6, for the sake of simplification of the drawing, the holding piece 43 provided in each of the restricting members 40A and 40B and the tape 50 wound around the holding piece 43 are not illustrated.

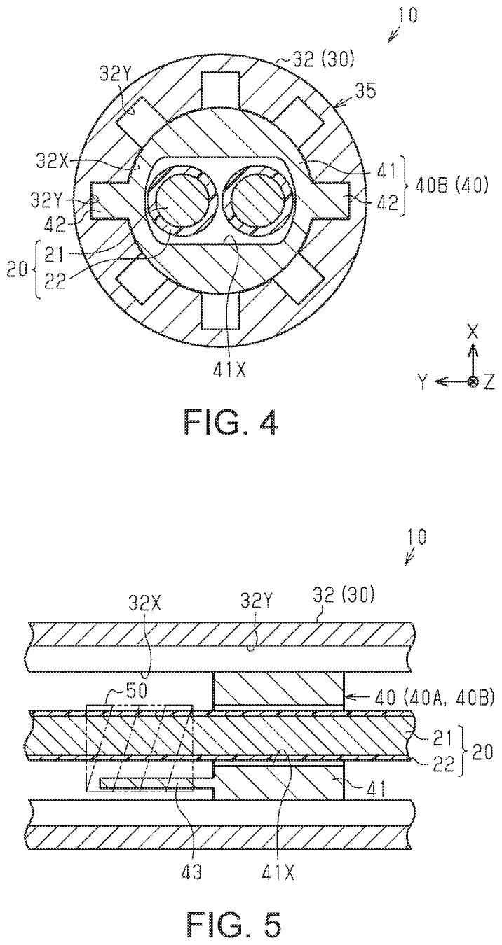

As shown in FIG. 6, in the present embodiment, extension directions in which the major axes of the housing spaces 41X of the restricting members 40A and 40B extend are set to be different directions in a horizontal cross section. More specifically, as shown in FIGS. 2 and 6, in the restricting member 40A provided in the linear portion 37 of the metal pipe 32, the protruding portions 42 are fitted into predetermined groove portions 32Y of the metal pipe 32 such that the major axis of the housing space 41X of the restricting member 40A extends in the up-down direction Z of the vehicle. With this configuration, the plurality of electric wires 20 that are passed through the housing space 41X of the restricting member 40A are arranged side by side in the up-down direction Z of the vehicle. Also, as shown in FIGS. 4 and 6, in the restricting member 40B provided in the linear portion 35 of the metal pipe 32, the protruding portions 42 are fitted into predetermined groove portions 32Y of the metal pipe 32 such that the major axis of the housing space 41X of the restricting member 40B extends in the width direction Y of the vehicle. That is, as shown in FIG. 6, the restricting member 40B is set such that, in a horizontal cross section, the major axis direction of the housing space 41X of the restricting member 40B is shifted by approximately 90 degrees relative to the major axis direction of the housing space 41X of the restricting member 40A in the circumferential direction of the metal pipe 32. Accordingly, the plurality of electric wires 20 that are passed through the housing space 41X of the restricting member 40B are arranged side by side in the width direction Y of the vehicle. With this configuration, as shown in FIGS. 1 and 6, the plurality of electric wires 20 can be twisted between the restricting member 40A and the restricting member 40B. Specifically, the two electric wires 20 can be twisted between the restricting member 40A and the restricting member 40B such that the two electric wires 20 that are arranged side by side in the up-down direction Z of the vehicle are arranged side by side in the width direction Y of the vehicle. At this time, in the internal space 32X of the bent portion 36 located between the restricting member 40A and the restricting member 40B, the two electric wires 20 are arranged side by side in the width direction Y of the vehicle. In other words, in the present embodiment, the positions of the plurality of electric wires 20 are restricted by the restricting members 40A and 40B such that the two electric wires 20 are arranged side by side in the width direction Y of the vehicle in the internal space 32X of the bent portion 36.

Here, in the bent portion 36, the metal pipe 32 is bent such that the extension direction of the metal pipe 32 extending in the front-rear direction X of the vehicle extends in the up-down direction Z of the vehicle. Accordingly, the bent inner side 36A of the bent portion 36 is provided between an upper surface of the linear portion 37 extending in the front-rear direction X of the vehicle and an outer circumferential surface of the linear portion 35 extending in the up-down direction Z of the vehicle, the outer circumferential surface facing toward the linear portion 37. As shown in FIG. 3, a straight line L1 extending from the bent inner side 36A in the radial direction of the metal pipe 32 extends in a direction perpendicular to the width direction Y of the vehicle. Accordingly, the two electric wires 20 that are arranged side by side in the width direction Y of the vehicle in the internal space 32X of the bent portion 36 do not overlap along the straight line L1 extending from bent inner side 36A in the radial direction of the metal pipe 32. That is, the two electric wires 20 in the bent portion 36 are positioned side by side relative to the bent inner side 36A of the bent portion 36. In other words, in the present embodiment, as shown in FIG. 6, the arrangement direction of the plurality of electric wires 20 is restricted by the restricting members 40A and 40B such that the two electric wires 20 are positioned side by side relative to the bent inner side 36A in the internal space 32X of the bent portion 36. FIG. 3 shows a state in which the outer circumferential surfaces of the plurality of electric wires 20 in the bent portion 36 are spaced apart from the inner circumferential surface of the metal pipe 32, but the outer circumferential surfaces of the plurality of electric wires 20 in the bent portion 36 may be individually in contact with the inner circumferential surface of the metal pipe 32.

Next, a method for producing the wire harness 10 will be described.

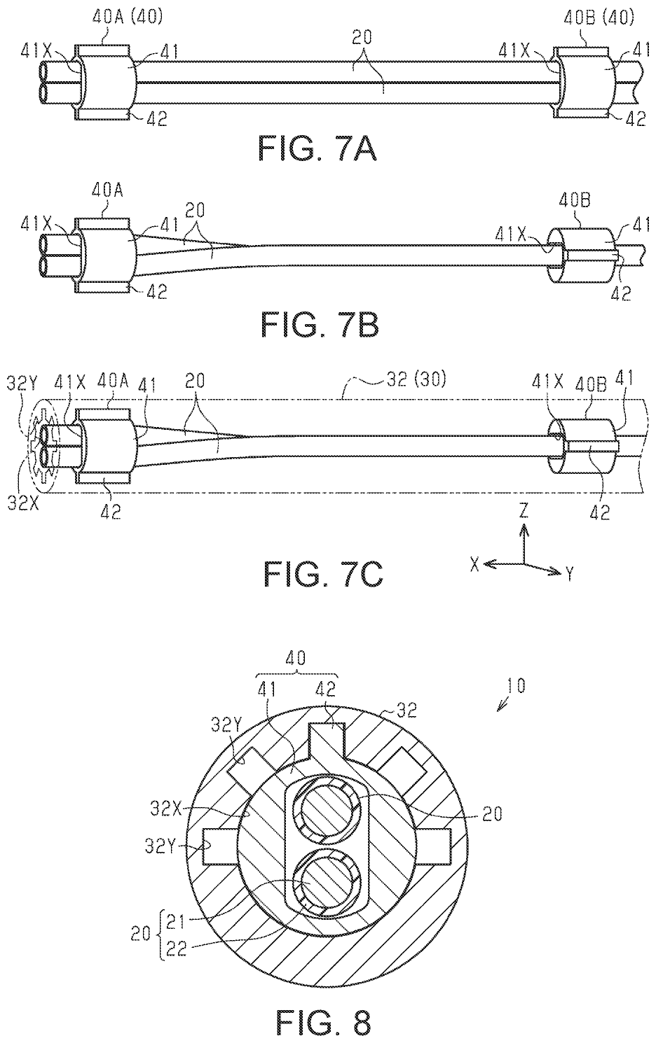

First, in a step shown in FIG. 7(a), a plurality of (two in this example) electric wires 20 and a plurality of (two in this example) restricting members 40A and 40B are prepared. Next, the two electric wires 20 are passed through the housing space 41X of the plurality of restricting members 40A and 40B. At this time, although not shown in the diagram, the tape 50 is wound around the two electric wires 20 drawn out from the housing space 41X together with each of the holding pieces 43 of the restricting members 40A and 40B as shown in FIG. 5 so as to cause the two electric wires 20 to be held by the holding pieces 43 (the restricting members 40A and 40B). In this step, the major axis directions of the housing spaces 41X of the two restricting members 40A and 40B are set so as to extend in the same direction. For example, the major axis direction of the housing space 41X of the restricting member 40A and the major axis direction of the housing space 41X of the restricting member 40B are set so as to extend in the up-down direction Z of the vehicle. At this time, in each housing space 41X, the arrangement direction of the two electric wires 20 is restricted to the major axis direction of the housing space 41X. Accordingly, the two electric wires 20 in this step are arranged side by side in the up-down direction Z of the vehicle.

Next, in a step shown in FIG. 7(b), the restricting member 40B is rotated 90 degrees in the circumferential direction. In doing so, the housing space 41X of the restricting member 40B is rotated such that the major axis direction of the housing space 41X of the restricting member 40B extends in the width direction Y of the vehicle. At this time, in the housing space 41X, the arrangement direction of the two electric wires 20 is restricted to the major axis direction of the housing space 41X. Accordingly, when the restricting member 40B is rotated 90 degrees in the circumferential direction, in the housing space 41X of the restricting member 40B, the two electric wires 20 are arranged side by side in the width direction Y of the vehicle. As a result, the two electric wires 20 are twisted between the restricting member 40A and the restricting member 40B such that the arrangement direction of the two electric wires 20 is changed from the up-down direction Z of the vehicle to the width direction Y of the vehicle.

Next, in the step shown in FIG. 7(c), the two electric wires 20 twisted as shown in FIG. 7(b) are passed through a metal pipe 32. At this time, the protruding portions 42 of the restricting members 40A and 40B are fitted into predetermined groove portions 32Y of the metal pipe 32. As a result of the protruding portions 42 being fitted into the groove portions 32Y, the positions of the restricting members 40A and 40B in the circumferential direction of the metal pipe 32 can be fixed. After that, the metal pipe 32 is subjected to bending processing so as to form a bent portion 36 as shown in FIG. 6 in the metal pipe 32 at a position between the restricting member 40A and the restricting member 40B. Due to the bending processing, as shown in FIG. 6, the electric wires 20 that are passed through the metal pipe 32 are also bent. At this time, the two electric wires 20 that are passed through the bent portion 36 are positioned side by side relative to the bent inner side 36A of the bent portion 36. During the bending processing, the protruding portions 42 of the restricting members 40A and 40B are fitted into the groove portions 32Y of the metal pipe 32, and it is therefore possible to prevent the restricting members 40A and 40B from rotating in the circumferential direction. Furthermore, the two electric wires 20 are held by the holding pieces 43 of the restricting members 40A and 40B during the bending processing (see FIG. 5), and it is therefore possible to prevent the restricting members 40A and 40B from being displaced in the lengthwise direction of the electric wires 20.

Next, advantageous effects of the present embodiment will be described.

(1) A wire harness 10 of the present embodiment includes: a cylindrical metal pipe 32 that collectively houses a plurality of electric wires 20; and a restricting member 40 that is provided within the metal pipe 32, the restricting member 40 including a housing space 41X through which the plurality of electric wires 20 are passed through and that is shaped and sized to be capable of restricting an arrangement direction of the plurality of electric wires 20 to a specific direction. Also, a plurality of groove portions 32Y are formed on an inner circumferential surface of the metal pipe 32 at a predetermined spacing in a circumferential direction of the metal pipe 32, and a protruding portion 42 that is fitted into one of the groove portions 32Y is formed in an outer circumferential surface of the restricting member 40. With this configuration, by adjusting a fitting position at which the protruding portion 42 of the restricting member 40 is fitted into one of the plurality of groove portions 32Y of the metal pipe 32, the arrangement direction of the electric wires 20 that can be restricted by the restricting member 40 can be set to a desired direction. Accordingly, the arrangement direction of the electric wires 20 within the metal pipe 32 can be adjusted to a desired direction. It is therefore possible to easily adjust the arrangement direction of the electric wires 20 such that the plurality of electric wires 20 are positioned side by side relative to the bent inner side 36A of the bent portion 36. As a result, it is possible to prevent the plurality of electric wires 20 from overlapping and coming into contact with an inner circumferential surface of the bent inner side 36A, and thus the thickness of the insulation coating 22 of each of the electric wires 20 can be prevented from being reduced. Accordingly, a reduction in the insulation reliability of the electric wires 20 can be preferably prevented.

(2) Also, the protruding portion 42 of the restricting member 40 is fitted into one of the groove portions 32Y of the metal pipe 32, and it is therefore possible to prevent the restricting member 40 from rotating in the circumferential direction of the metal pipe 32 in the internal space 32X of the metal pipe 32. With this configuration, a positional offset of the restricting member 40 in the circumferential direction can be preferably prevented. Accordingly, the arrangement direction of the plurality of electric wires 20 can be preferably kept to a desired direction.

(3) A holding piece 43 that extends in a direction in which the plurality of electric wires 20 drawn out from the housing space 41X extend is formed on an end face of the restricting member 40. Furthermore, tape 50 is wound around the plurality of electric wires 20 together with the holding piece 43 so as to cause the plurality of electric wires 20 to be held by the holding piece 43. With this configuration, a positional offset of the restricting member 40 in the lengthwise direction of the plurality of electric wires 20 can be preferably prevented.

(4) The housing space 41X is configured to have a flat horizontal cross section. Furthermore, the housing space 41X is sized to be capable of collectively housing the plurality of electric wires 20 and restricting the arrangement direction of the plurality of electric wires 20 to only one direction. With this configuration, a plurality of electric wires 20 can be collectively passed through one housing space 41X, and thus ease of attaching the restricting member 40 to the plurality of electric wires 20 can be improved. Also, the arrangement direction of the plurality of electric wires 20 can be restricted to only one direction, and thus the arrangement direction of the electric wires 20 in the internal space 32X of the metal pipe 32 can be easily adjusted to a desired direction.

(5) The restricting member 40 is not provided in the bent portion 36 of the metal pipe 32, and is provided only in the linear portions 35 and 37 of the metal pipe 32. With this configuration, the occurrence of a problem in which the metal pipe 32 is unlikely to be bent as a result of the restricting member 40 being provided can be prevented.

(6) The problem of the conventional wire harness shown in FIG. 10 where the thickness of the insulation coating 91 of an electric wire 90 is reduced becomes noticeable when the hard metal pipe 80 is used as the protective tube for housing the electric wires 90. In contrast, in the wire harness 10 of the present embodiment, the restricting member 40 is provided in the internal space 32X of the metal pipe 32, and the arrangement direction of the plurality of electric wires 20 is adjusted by the restricting member 40. With this configuration, it is possible to prevent the plurality of electric wires 20 from overlapping and coming into contact with the inner circumferential surface of the hard metal pipe 32, and thus the occurrence of the problem where the thickness of the insulation coating 22 of the electric wire 20 is reduced can be preferably prevented.

### Other Embodiments

The embodiment given above can be carried out by making modifications as described below. The embodiment given above and variations, which will be given below, may be combined and carried out provided they don't technically contradict each other.

There is no particular limitation on the number of groove portions 32Y of the embodiment given above.

In the embodiment given above, the groove portions 32Y are formed over the entire inner circumferential surface of the metal pipe 32 in the circumferential direction of the metal pipe 32. However, for example, the groove portions 32Y may be formed only in a partial region of the inner circumferential surface of the metal pipe 32 in the circumferential direction of the metal pipe 32.

For example, as shown in FIG. 8, the groove portions 32Y may be formed only in a half-region of the inner circumferential surface of the metal pipe 32 in the circumferential direction of the metal pipe 32. In the metal pipe 32 shown in FIG. 8, the groove portions 32Y are formed only in an upper half region of the inner circumferential surface of the metal pipe 32. In the present variation, five groove portions 32Y are formed in the inner circumferential surface of the metal pipe 32.

In the embodiment given above, the plurality of groove portions 32Y are formed in the inner circumferential surface of the metal pipe 32 equidistantly in the circumferential direction of the metal pipe 32, but there is no particular limitation on the positions of the groove portions 32Y. For example, there is no particular limitation on the positions of the plurality of groove portions 32Y as long as they are formed on the inner circumferential surface of the metal pipe 32 at a predetermined spacing in the circumferential direction of the metal pipe 32.

In the embodiment given above, the protruding portions 42 are formed extending over the entire length of the main body portion 41 in the lengthwise direction of the main body portion 41, but the configuration is not limited thereto. For example, the protruding portions 42 may be formed partially in a portion of the main body portion 41 in the lengthwise direction of the main body portion 41.

There is no particular limitation on the number of protruding portions 42 of the embodiment given above. For example, there is no particular limitation on the number of protruding portions 42 as long as the number of protruding portions 42 is less than or equal to the number of groove portions 32Y of the metal pipe 32. For example, in the embodiment given above, the metal pipe 32 includes eight groove portions 32Y, and thus the number of protruding portions 42 can be set to 1 to 8. In the variation shown in FIG. 8, the metal pipe 32 includes five groove portions 32Y, and thus the number of protruding portions 42 can be set to 1 to 5. Furthermore, in the variation shown in FIG. 8, one protruding portion 42 is formed on the outer circumferential surface of the restricting member 40.

In the embodiment given above, the protruding portions 42 is provided extending along an extension line of the major axis of the housing space 41X. However, there is no particular limitation on the position of the protruding portions 42. For example, the protruding portions 42 may be provided extending along an extension line of the minor axis of the housing space 41X.

In the embodiment given above, two protruding portions 42 are provided at positions approximately 180 degrees apart from each other in the circumferential direction of the main body portion 41. However, there is no particular limitation on the positions of the protruding portions 42. For example, two protruding portions 42 may be provided at positions approximately 90 degrees apart from each other in the circumferential direction of the main body portion 41.

In the embodiment given above, the housing space 41X is configured to have an oval horizontal cross section, but the configuration is not limited thereto. For example, the horizontal cross section of the housing space 41X may have a circular shape, an elliptical shape, or a quadrangular shape.

The restricting member 40 of the embodiment given above is configured to include a housing space 41X that collectively houses a plurality of electric wires 20, but the configuration is not limited thereto. For example, the restricting member 40 may be configured to include a plurality of housing spaces in each of which one of the plurality of electric wires 20 is individually housed. The electric wires 20 may be press-fitted into the housing spaces in one-to-one correspondence. In this case, the electric wires 20 can be fixed to the restricting member 40 as a result of the electric wires 20 being press-fitted into the housing spaces, and thus the holding piece 43 of the restricting member 40 and the tape 50 can be omitted.

There is no particular limitation on the position of the holding piece 43 of the embodiment given above.

In the embodiment given above, the tape 50 is used as a specific example of the fixing member for fixing the plurality of electric wires 20 to the holding piece 43, but the configuration is not limited thereto. For example, instead of the tape 50, a cable tie or a crimping ring made of resin or metal, or the like may be used as the fixing member.

In the embodiment given above, the metal pipe 32 is configured to have a cylindrical shape, but the configuration is not limited thereto. The metal pipe 32 may be configured to have, for example, a quadrangular cylindrical shape, an elongated cylindrical shape, or an elliptic cylindrical shape. Even in this case, the groove portions 32Y are formed in the inner circumferential surface of the metal pipe 32.

In the embodiment given above, for example, the metal pipe 32 is bent into a two-dimensional shape, but the configuration is not limited thereto. For example, the metal pipe 32 may be bent into a three-dimensional shape.

In the embodiment given above, the external member 30 that includes corrugated tubes 31 and 33 and a metal pipe 32 is used as a specific example. The configuration is not limited thereto, and, for example, the external member 30 may be configured without including the corrugated tube 31 or the corrugated tubes 31 and 33, or in other words, may be configured so as to include only the metal pipe 32. Also, the corrugated tubes 31 and 33 and the metal pipe 32 may be replaced with other external members. For example, the metal pipe 32 may be replaced with a resin pipe. That is, as the protective tube, a resin pipe may be used as a specific example. The resin pipe in this case is configured to be harder than, for example, the insulation coatings 22 of the electric wires 20.

In the embodiment given above, unshielded electric wires are used as a specific example of the electric wires 20. However, shielded electric wires that have an electromagnetic shielding structure may be used as a specific example of the electric wires 20.

In the embodiment given above, two electric wires 20 are passed through the external member 30. However, there is no particular limitation on the number of electric wires 20, and the number of electric wires 20 can be changed according to the specifications of the vehicle. For example, the number of electric wires that are passed through the external member 30 may be one, or three or more. For example, low-voltage electric wires that connect a low-voltage battery and various types of low-voltage devices (for example, a lamp, a car stereo, and the like) may be added as the electric wires that are passed through the external member 30. Alternatively, only low-voltage electric wires may be used.

The positional relationship between the inverter 11 and the high-voltage battery 12 in the vehicle is not limited to that described in the embodiment given above, and may be changed as appropriate according to the configuration of the vehicle.

In the embodiment given above, the inverter 11 and the high-voltage battery 12 are used as the electric devices that are connected by the wire harness 10, but the configuration is not limited thereto. For example, the wire harness 10 may be applied to an electric wire that connects the inverter 11 and a motor for driving wheels. That is, the wire harness 10 is applicable to anything that can electrically connect electric devices that are mounted on a vehicle.

In some implementation examples of the present disclosure, the restricting member 40 may be disposed at an intermediate portion of the protective tube 32 in the lengthwise direction of the protective tube 32 that is opposite to opposing opening edges of the protective tube 32, and the restricting member 40 disposed at the intermediate portion of the protective tube 32 may be configured such that it does not come into contact or engage with the opening edges of the protective tube 32.

In some implementation examples of the present disclosure, when the protective tube 32 is viewed in a cross section, a portion of the outer circumferential surface of the restricting member 40 may be spaced apart from the inner circumferential surface of the protective tube 32, and a portion of the inner circumferential surface of the restricting member 40 may be spaced apart from the outer circumferential surfaces of the electric wires 20. For example, when the protective tube 32 is viewed in a cross section, an empty space or gap that allows a gas to flow therethrough may be defined between the protective tube 32 and the restricting member 40 and/or between the restricting member 40 and the electric wires 20.

In some implementation examples of the present disclosure, the protective tube 32 can include a bent portion 36. The wire harness 10 may include: a first restricting member 40A that is disposed in the protective tube 32 at a position spaced apart from the bent portion 36 of the protective tube 32 in a first axis direction; and a second restricting member 40B that is disposed in the protective tube 32 at a position spaced apart from the bent portion 36 of the protective tube 32 in a second axis direction. The bent portion 36 is located between the first restricting member 40A and the second restricting member 40B, and a continuous empty space that does not include a restricting member may continuously extend along the electric wires 20 between the first restricting member 40A and the second restricting member 40B.

In some implementation examples of the present disclosure, when the housing space 41X of the restricting member 40 is viewed in a cross section, the housing space 41X of the restricting member 40 may be a through hole that has an anisotropic shape such as a rectangular shape, and the anisotropic-shaped through hole (41X) of the restricting member 40 may be configured to bundle the plurality of electric wires 20 into an anisotropic-shaped bundle.

In some implementation examples of the present disclosure, the housing space 41X of the restricting member 40 may be configured to loosely house the anisotropic-shaped bundle of the plurality of electric wires 20. For example, the housing space 41X may allow the anisotropic-shaped bundle of the plurality of electric wires 20 to move in the radial direction within the housing space 41X, with the bundle maintaining its anisotropic shape.

In some implementation examples of the present disclosure, the anisotropic-shaped bundle of the plurality of electric wires 20 may be restricted or forcibly oriented at a position in the first axis direction by the first restricting member 40A so as to have a first rotation angle relative to a cross section of the protective tube 32 (FIG. 2). The anisotropic-shaped bundle of the plurality of electric wires 20 may be restricted or forcibly oriented at a position in the second axis direction by the second restricting member 40B so as to have a second rotation angle relative to a cross section of the protective tube 32 (FIG. 4). The first rotation angle (FIG. 2) and the second rotation angle (FIG. 4) may have a predetermined phase difference, for example, a phase difference of 90 degrees.

In some implementation examples of the present disclosure, the plurality of electric wires 20 may include a twisted portion at a position in a third axis direction that is between the position in the first axis direction and the position in the second axis direction and excludes the bent portion 36 (FIG. 6).

In some implementation examples of the present disclosure, the plurality of electric wires 20 may be disposed in state floating from the inner circumferential surface of the protective tube 32 at least in the bent portion 36.

In some implementation examples of the present disclosure, the inner circumferential surface of the protective tube 32 may include a plurality of rails that extend over the entire length of the protective tube 32 and define a plurality of groove portions 32Y between the plurality of rails The restricting member 40 may include a cylindrical main body portion 41 and a protruding portion 42 that radially protrudes outward from the cylindrical main body portion 41. The cylindrical main body portion 41 may be configured to come into contact with and be supported by radial inner surfaces of the protective tube 32 that are top surfaces of the plurality of rails The protruding portion 42 may be configured to engage with one groove portion 32Y selected from among the plurality of groove portions 32Y of the protective tube 32 such that the restricting member 40 maintains a desired rotation angle relative to the protective tube 32.

### Technical Field

The present disclosure relates to a wire harness.

### Background Art

Conventionally, a wire harness for use in a vehicle such as a hybrid vehicle or an electric automobile includes electric wires that electrically connect electric devices such as a high-voltage battery and an inverter (see, for example, Patent Document 1). In the wire harness, the plurality of electric wires are collectively covered by a metal pipe, for the purpose of protecting the electric wires and reducing noise.

### CITATION LIST

### Patent Document

Patent Document 1: JP 2016-58137A

### SUMMARY OF INVENTION

### Technical Problem

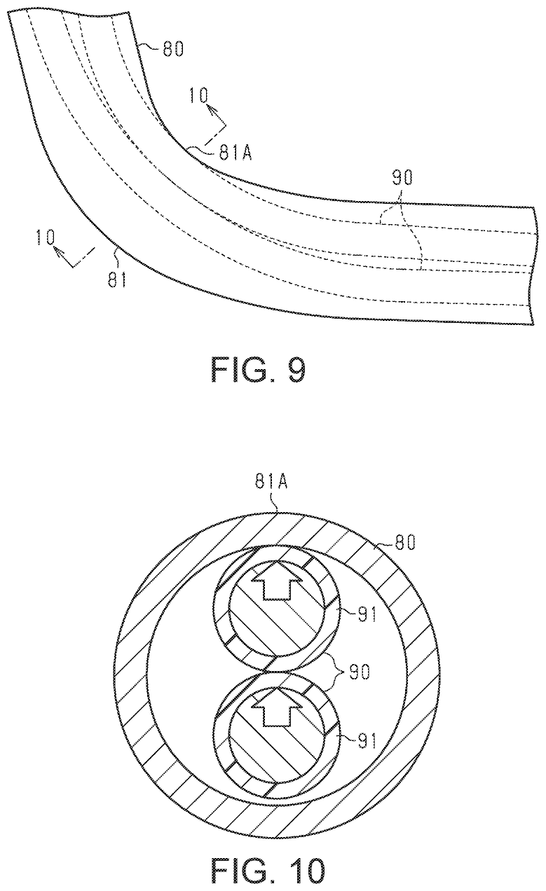

However, in the wire harness described above, bending processing is performed on the metal pipe with the plurality of electric wires passed through the metal pipe. Due to the bending processing, as shown in FIG. 9, electric wires 90 that are passed through a metal pipe 80 are also bent together with the metal pipe 80. As a result, the electric wires 90 come into contact with the inner circumferential surface of the metal pipe 80 on a bent inner side 81A of a bent portion 81 of the metal pipe 80. At this time, a situation may occur in which the plurality of electric wires 90 are arranged overlapping each other on the bent inner side 81A, as a result of which, the innermost one of the plurality of electric wires 90 comes into contact with the inner circumferential surface of the bent inner side 81A of the bent portion 81 of the metal pipe 80, and the outermost one of the plurality of electric wires 90 that is close to the outer side of the bent portion 81 overlaps the innermost electric wire from the outer side and presses the innermost electric wire toward the inner circumferential surface of the bent inner side 81A of the bent portion 81 of the metal pipe 80. In this case, as shown in FIG. 10, a pressing force that presses an outer circumferential surface of each electric wire 90 against the inner circumferential surface of the metal pipe 80 on the bent inner side 81A is increased. That is, the outer circumferential surface of the innermost electric wire 90 comes into contact with the inner circumferential surface of the bent inner side 81A, with the plurality of electric wires 90 being arranged overlapping each other, and thus the pressing force of the plurality of electric wires 90 acts on a contact portion between the outer circumferential surface of the innermost electric wire 90 and the inner circumferential surface of the metal pipe 80 (see the arrows shown in FIG. 10). As a result, at the contact portion between the outer circumferential surface of the innermost electric wire 90 and the inner circumferential surface of the metal pipe 80, a problem may occur in which the thickness of the insulation coating 91 of the electric wire 90 is reduced, which diminishes the insulation reliability of the electric wire 90.

Accordingly, it is an object of the present disclosure to provide a wire harness in which a reduction in the insulation reliability can be suppressed.

### Solution to Problem

A wire harness according to the present disclosure includes: a plurality of electric wires; a cylindrical protective tube that collectively houses the plurality of electric wires; a restricting member that is provided within the protective tube and includes a housing space through which the plurality of electric wires are passed and that is shaped and sized to be capable of restricting an arrangement direction of the plurality of electric wires to a specific direction; a plurality of groove portions that are formed in an inner circumferential surface of the protective tube at a predetermined spacing in a circumferential direction of the protective tube; and a protruding portion that is formed on an outer circumferential surface of the restricting member and is fitted into one of the groove portions.

### Advantageous Effects of Invention

The wire harness according to the present disclosure provides the effect of suppressing a reduction in the insulation reliability.

### BRIEF DESCRIPTION OF DRAWINGS

FIG. 1 is a schematic side view of a wire harness according to one embodiment.

FIG. 2 is a schematic horizontal cross-sectional view of the wire harness according to one embodiment (a cross-sectional view taken along the line 2-2 shown in FIG. 1).

FIG. 3 is a schematic horizontal cross-sectional view of the wire harness according to one embodiment (a cross-sectional view taken along the line 3-3 shown in FIG. 1).

FIG. 4 is a schematic horizontal cross-sectional view of the wire harness according to one embodiment (a cross-sectional view taken along the line 4-4 shown in FIG. 1).

FIG. 5 is a schematic cross-sectional view of the wire harness according to one embodiment.

FIG. 6 is a schematic perspective view of the wire harness according to one embodiment.

FIGS. 7(a) to 7(c) are schematic perspective views illustrating a method for producing a wire harness according to one embodiment.

FIG. 8 is a schematic horizontal cross-sectional view of a wire harness according to a variation.

FIG. 9 is a schematic side view of a conventional wire harness.

FIG. 10 is a schematic horizontal cross-sectional view of the conventional wire harness (a cross-sectional view taken along the line 10-10 shown in FIG. 9).

### DESCRIPTION OF EMBODIMENTS

A specific example of the wire harness according to the present disclosure will be described below with reference to the drawings. In the accompanying drawings, some constituent elements may be shown enlarged or simplified for the sake of ease of understanding. Also, the scaling factor of the constituent elements may vary from diagram to diagram. It is to be noted that the present invention is not limited to examples given below, the scope of the present invention is indicated by the appended claims, and all changes that come within the meaning and range of equivalency of the claims are intended to be embraced within the scope of the present invention.

A wire harness 10 shown in FIG. 1 electrically connects two, three or more electric devices (devices). The wire harness 10 electrically connects, for example, an inverter 11 and a high-voltage battery 12, the inverter 11 being provided in a front portion of a vehicle such as a hybrid vehicle or an electric automobile, and the high-voltage battery 12 being provided in a rear portion of the vehicle relative to the inverter 11. The wire harness 10 is routed, for example, under the floor of the vehicle or the like. The inverter 11 is connected to a motor (not shown) that is for driving wheels and serves as a power source for driving the vehicle. The inverter 11 generates alternating current power from the direct current power of the high-voltage battery 12, and supplies the generated alternating current power to the motor. The high-voltage battery 12 is a battery that can supply, for example, a voltage of several hundred volts.

In the description given below, the left-right direction in FIG. 1 will be referred to as “the front-rear direction X of the vehicle”, a direction perpendicular to the plane of FIG. 1 will be referred to as “the width direction Y of the vehicle”, and the up-down direction in FIG. 1 will be referred to as “the up-down direction Z of the vehicle”.

The wire harness 10 includes a plurality of (two in the present embodiment) electric wires 20 and an external member 30 that surrounds the electric wires 20. One end portion of each electric wire 20 is connected to the inverter 11, and the other end portion of each electric wire 20 is connected to the high-voltage battery 12. The electric wires 20 are bent into, for example, a two-dimensional shape or a three-dimensional shape. For example, the electric wires 20 are bent into a predetermined shape according to the routing path of the wire harness 10. The electric wires 20 are, for example, high-voltage electric wires that can support high voltages and large currents. The electric wires 20 may be, for example, unshielded electric wires that do not have an electromagnetic shielding structure or shielded electric wires that have an electromagnetic shielding structure. The electric wires 20 of the present embodiment are unshielded electric wires.

As shown in FIGS. 2 and 3, each electric wire 20 includes a core wire 21 composed of a conductor and an insulation coating 22 that covers an outer circumference of the core wire 21. As the core wire 21, for example, a twisted wire composed of a plurality of metal strands that are twisted together, a columnar conductor (a single core wire, a bus bar, or the like) composed of a columnar metal rod that has a solid structure, a cylindrical conductor (a pipe conductor) that has a hollow structure, or the like can be used. Alternatively, as the core wire 21, a combination of twisted wires, columnar conductors, or cylindrical conductors may be used. The core wire 21 of the present embodiment is a single core wire. As the material of the core wire 21, for example, a metal material such as a copper-based metal material or an aluminum-based metal material can be used. The core wire 21 is formed through extrusion molding, for example.

The cross section of the core wire 21 may have any shape, the cross section being obtained by cutting the core wire 21 along a plane perpendicular to the lengthwise direction of the core wire 21. That is, the horizontal cross-section of the core wire 21 may have any shape. The horizontal cross-section of the core wire 21 may have, for example, a circular shape, a semicircular shape, a polygonal shape, a square shape, or a flat shape. In the specification of the present application, the term “flat shape” may refer to a shape that has short sides or minor axes and long sides or major axes and has an aspect ratio other than 1. The term “flat shape” encompasses, for example, a rectangular shape, an oval shape, an elliptical shape, and the like. The term “rectangular shape” used in the specification of the present application refers to a shape that has long sides and short sides, and excludes a square shape. The term “rectangular shape” used in the specification of the present application also encompasses a shape with chamfered corners and a shape with rounded corners. The horizontal cross-section of the core wire 21 of the present embodiment has a circular shape.

The insulation coating 22 covers, for example, the entire outer circumferential surface of the core wire 21 in an intimate contact manner. The insulation coating 22 is made of an insulating material such as a synthetic resin. The insulation coating 22 can be formed by, for example, performing extrusion molding (extrusion coating) on the core wire 21.

The external member 30 has an overall elongated cylindrical shape. The plurality of electric wires 20 are passed through an internal space of the external member 30. The external member 30 is formed so as to surround all outer circumferences of the plurality of electric wires 20. The external member 30 protects the electric wires 20 that are housed in the external member 30 from projectiles and water droplets. As the external member 30, for example, a pipe made of metal or resin, a protector made of resin, a flexible corrugated tube made of resin or the like, a water-resistant cover made of rubber, or a combination thereof can be used.

As shown in FIG. 1, the external member 30 includes a corrugated tube 31, a metal pipe 32, and a corrugated tube 33. The corrugated tube 31 is provided so as to, for example, cover end portions of the electric wires 20 that are on the inverter 11 side. The corrugated tube 33 is provided so as to, for example, cover end portions of the electric wires 20 that are on the high-voltage battery 12 side. The metal pipe 32 is provided so as to cover the electric wires 20 between the corrugated tube 31 and the corrugated tube 33. As the material of the corrugated tubes 31 and 33, for example, a conductive resin material or a non-conductive resin material can be used. As the resin material, for example, a synthetic resin such as polyolefin, polyamide, polyester, or ABS resin can be used. As the material of the metal pipe 32, a metal material such as a copper-based metal material, an iron-based metal material, or an aluminum-based metal material can be used. The metal pipe 32 has, in addition to a protective function for protecting the electric wires 20 from projectiles, and the like, an electromagnetic shielding function for protecting the plurality of electric wires 20 from electromagnetic waves.

The metal pipe 32 has an overall elongated cylindrical shape. The metal pipe 32 of the present embodiment includes a linear portion 35 that extends linearly along the up-down direction of the vehicle at an end portion that is on the corrugated tube 31 side, a bent portion 36 that is formed at one end portion of the linear portion 35, and a linear portion 37 that extends linearly from the bent portion 36 in the front-rear direction X of the vehicle. The bent portion 36 includes a bent inner side 36A.

As shown in FIGS. 2 to 4, the metal pipe 32 includes an internal space 32X. In the internal space 32X of the metal pipe 32, the plurality of electric wires 20 are provided side by side. The metal pipe 32 of the present embodiment has a cylindrical shape. That is, the metal pipe 32 is configured such that the inner circumference and the outer circumference of the metal pipe 32 have a circular cross section as a whole. The internal space 32X of the metal pipe 32 has, for example, a circular horizontal cross section.

In an inner circumferential surface of the metal pipe 32, a plurality of (eight in this example) groove portions 32Y are formed recessed from the inner circumferential surface of the metal pipe 32 toward the outside of the metal pipe 32 in the radial direction. The plurality of groove portions 32Y are provided at a predetermined spacing in the circumferential direction of the metal pipe 32. The plurality of groove portions 32Y are formed, for example, extending radially approximately the central axis of the metal pipe 32 in the radial direction. The plurality of groove portions 32Y are provided, for example, equidistantly in the circumferential direction of the metal pipe 32. The plurality of groove portions 32Y are formed, for example, over the entire circumferential direction of the inner circumferential surface of the metal pipe 32. The eight groove portions 32Y of the present embodiment are provided at positions at intervals of 45 degrees in the circumferential direction of the metal pipe 32. The groove portions 32Y are formed so as to, for example, expand the internal space 32X radially outward. Each groove portion 32Y is formed extending over the entire length of the metal pipe 32 in the lengthwise direction of the metal pipe 32. Each groove portion 32Y can have a horizontal cross section of any shape. The horizontal cross section of each groove portion 32Y may have, for example, a semicircular shape, a polygonal shape, or a flat shape. Each groove portion 32Y of the present embodiment has a rectangular horizontal cross section.

Here, the metal pipe 32 is formed through extrusion molding, for example. The metal pipe 32 described above is formed so as to have, for example, a horizontal cross section with a predetermined shape over the entire length of the metal pipe 32 in the length direction.

In the wire harness 10 shown in FIG. 1, the plurality of electric wires 20 are disposed within the metal pipe 32 such that the plurality of electric wires 20 are positioned side by side relative to the bent inner side 36A of the bent portion 36. In other words, in the wire harness 10, the plurality of electric wires 20 are disposed within the metal pipe 32 such that the plurality of electric wires 20 do not overlap a straight line that extends from the bent inner side 36A in the radial direction of the metal pipe 32.

The wire harness 10 includes one or more (two in this example) restricting members 40 that restrict the positions of the plurality of electric wires 20 within the metal pipe 32. The plurality of restricting members 40 are provided, for example, spaced apart from each other in the lengthwise direction of the metal pipe 32. The restricting members 40 are provided, for example, at an intermediate portion of the metal pipe 32 in the lengthwise direction of the metal pipe 32. The restricting members 40 are provided only in, for example, the linear portions 35 and 37 out of the linear portions 35 and 37 and the bent portion 36 of the metal pipe 32. In other words, a restricting member 40 is not provided in the bent portion 36. The restricting members 40 are respectively provided in, for example, regions of the linear portions 35 and 37 near the bent portion 36.

As shown in FIG. 2, each restricting member 40 includes a cylindrical main body portion 41. The main body portion 41 is shaped to be capable of being fitted into the internal space 32X of the metal pipe 32. The main body portion 41 is formed such that the outer circumference of the main body portion 41 has a cross-sectional shape corresponding to the cross-sectional shape of the inner circumference of the metal pipe 32. The outer circumference of the main body portion 41 of the present embodiment has a circular cross section. The outer diameter of the main body portion 41 is set to be, for example, slightly smaller than the inner diameter of the metal pipe 32. In a state in which the restricting members 40 are housed in the internal space 32X of the metal pipe 32, for example, at least a portion of the outer circumferential surface of the main body portion 41 is in contact with the inner circumferential surface of the metal pipe 32.

As shown in FIG. 5, the main body portion 41 is formed, for example, extending in the lengthwise direction of the metal pipe 32. The lengthwise direction of the main body portion 41 extends in a direction that matches, for example, the lengthwise direction of the metal pipe 32. In a center portion of the main body portion 41, a housing space 41X that extends in the lengthwise direction is formed.

As shown in FIG. 2, the housing space 41X is formed so as to, for example, allow the plurality of electric wires 20 to be collectively passed therethrough. The housing space 41X is sized to be capable of restricting the arrangement direction (alignment direction) of the plurality of electric wires 20 to a specific direction. The housing space 41X of the present embodiment is sized to be capable of restricting, for example, the arrangement direction of the plurality of electric wires 20 in a horizontal cross section to one direction. The housing space 41X has, for example, a flat horizontal cross section. The housing space 41X of the present embodiment has an oval-shaped horizontal cross section. That is, the inner circumference of the housing space 41X has an oval cross section. In other words, the housing space 41X of the present embodiment has an elongated cylindrical shape. Here, the term “oval shape” used in the specification of the present application refers to a shape that includes two parallel lines that have a substantially equal length and two arc portions that connect the end portions of the two parallel lines. In the specification of the present application, in the oval shape, an axis that passes through the center of the oval shape and extends in parallel to the two parallel lines is referred to as the “major axis”, and an axis that passes through the center of the oval shape and extends in a direction perpendicular to the major axis is referred to as the “minor axis”. A direction in which the major axis extends is referred to as a “major axis direction”, and a direction in which the minor axis extends is referred to as a “minor axis direction”.

In the housing space 41X, a length dimension that extends along the major axis and a length dimension that extends along the minor axis are set such that, for example, the plurality of electric wires 20 can be arranged side by side in the major axis direction, and cannot be arranged side by side in the minor axis direction.

One or more protruding portions 42 that can be fitted into one or more groove portions 32Y of the metal pipe 32 are formed on the outer circumferential surface of the main body portion 41. The protruding portions 42 are formed protruding from the outer circumferential surface of the main body portion 41 toward the outside of the main body portion 41 in the radial direction. The protruding portions 42 are formed continuously from, for example, the main body portion 41 as a single piece. The number of protruding portions 42 is set to be less than or equal to the number of groove portions 32Y of the metal pipe 32. In the present embodiment, two protruding portions 42 are formed on the outer circumferential surface of the main body portion 41.

The plurality of protruding portions 42 are provided at positions spaced apart from each other in the circumferential direction of the main body portion 41. The plurality of protruding portions 42 are provided, for example, at such positions that all of the plurality of protruding portions 42 can be fitted into the groove portions 32Y of the metal pipe 32. In the present embodiment, two protruding portions 42 are positioned approximately 180 degrees apart from each other in the circumferential direction of the main body portion 41. The two protruding portions 42 are provided on, for example, on an extension line of the major axis of the housing space 41X.

The horizontal cross section of each protruding portion 42 is shaped and sized to be capable of being fitted into a groove portion 32Y of the metal pipe 32. The horizontal cross section of each protruding portion 42 of the present embodiment has a rectangular shape that corresponds to the shape of the horizontal cross section of each groove portion 32Y. The size of the horizontal cross section of each protruding portion 42 is slightly smaller than the size of the horizontal cross section of each groove portion 32Y. In a state in which the protruding portion 42 is fitted into the groove portion 32Y, for example, at least a portion of the outer circumferential surface of the protruding portion 42 is in contact with the inner circumferential surface of the groove portion 32Y. Each protruding portion 42 is formed, for example, extending over the entire length of the main body portion 41 in the lengthwise direction.

As shown in FIG. 5, a holding piece 43 protruding from an end face of the main body portion 41 in the lengthwise direction is formed on an end face of the main body portion 41 in the lengthwise direction. The holding piece 43 is formed protruding in a direction away from the housing space 41X. The holding piece 43 is formed protruding in a direction in which the plurality of electric wires 20 that are drawn out from the housing space 41X extend. The holding piece 43 has, for example, a flat plate shape. The holding piece 43 is formed continuously from, for example, the main body portion 41 as one piece. The restricting member 40 of the present embodiment is a single component in which the main body portion 41, the protruding portion 42, and the holding piece 43 are unitarily formed.

As shown in FIG. 2, the holding piece 43 is provided, for example, extending along the housing space 41X. The holding piece 43 can have, for example, a horizontal cross section of any shape. The horizontal cross section of the holding piece 43 of the present embodiment has a rectangular shape that includes long sides that extend in a direction parallel to the major axis direction of the housing space 41X and short sides that extend in a direction parallel to the minor axis direction of the housing space 41X.

As shown in FIG. 5, tape 50 is used to fix the holding piece 43 to the plurality of electric wires 20 that are drawn out from the housing space 41X. In other words, the tape 50 is spirally wound around the holding piece 43 together with the plurality of electric wires 20 that are drawn out from the housing space 41X, and the plurality of electric wires 20 are thereby held by the holding piece 43. As a result, the position of the restricting member 40 in the lengthwise direction of the plurality of electric wires 20 can be fixed.

As shown in FIG. 6, the plurality of restricting members 40 includes a restricting member 40A that is provided in the linear portion 37 and a restricting member 40B that is provided in the linear portion 35. The bent portion 36 of the metal pipe 32 is disposed between the restricting member 40A and the restricting member 40B. In the restricting members 40A and 40B, the angles of rotation of the restricting members 40A and 40B are adjusted such that the major axis direction of the housing space 41X of the restricting member 40A and the major axis direction of the housing space 41X of the restricting member 40B are different from each other by relatively rotating the restricting members 40A and 40B. In doing so, the positions of the plurality of electric wires 20 are restricted such that the plurality of electric wires 20 are positioned side by side relative to the bent inner side 36A of the bent portion 36 of the metal pipe 32. This will be described in detail below with reference to FIGS. 2 to 4 and FIG. 6. In FIG. 6, for the sake of simplification of the drawing, the holding piece 43 provided in each of the restricting members 40A and 40B and the tape 50 wound around the holding piece 43 are not illustrated.

As shown in FIG. 6, in the present embodiment, extension directions in which the major axes of the housing spaces 41X of the restricting members 40A and 40B extend are set to be different directions in a horizontal cross section. More specifically, as shown in FIGS. 2 and 6, in the restricting member 40A provided in the linear portion 37 of the metal pipe 32, the protruding portions 42 are fitted into predetermined groove portions 32Y of the metal pipe 32 such that the major axis of the housing space 41X of the restricting member 40A extends in the up-down direction Z of the vehicle. With this configuration, the plurality of electric wires 20 that are passed through the housing space 41X of the restricting member 40A are arranged side by side in the up-down direction Z of the vehicle. Also, as shown in FIGS. 4 and 6, in the restricting member 40B provided in the linear portion 35 of the metal pipe 32, the protruding portions 42 are fitted into predetermined groove portions 32Y of the metal pipe 32 such that the major axis of the housing space 41X of the restricting member 40B extends in the width direction Y of the vehicle. That is, as shown in FIG. 6, the restricting member 40B is set such that, in a horizontal cross section, the major axis direction of the housing space 41X of the restricting member 40B is shifted by approximately 90 degrees relative to the major axis direction of the housing space 41X of the restricting member 40A in the circumferential direction of the metal pipe 32. Accordingly, the plurality of electric wires 20 that are passed through the housing space 41X of the restricting member 40B are arranged side by side in the width direction Y of the vehicle. With this configuration, as shown in FIGS. 1 and 6, the plurality of electric wires 20 can be twisted between the restricting member 40A and the restricting member 40B. Specifically, the two electric wires 20 can be twisted between the restricting member 40A and the restricting member 40B such that the two electric wires 20 that are arranged side by side in the up-down direction Z of the vehicle are arranged side by side in the width direction Y of the vehicle. At this time, in the internal space 32X of the bent portion 36 located between the restricting member 40A and the restricting member 40B, the two electric wires 20 are arranged side by side in the width direction Y of the vehicle. In other words, in the present embodiment, the positions of the plurality of electric wires 20 are restricted by the restricting members 40A and 40B such that the two electric wires 20 are arranged side by side in the width direction Y of the vehicle in the internal space 32X of the bent portion 36.

Here, in the bent portion 36, the metal pipe 32 is bent such that the extension direction of the metal pipe 32 extending in the front-rear direction X of the vehicle extends in the up-down direction Z of the vehicle. Accordingly, the bent inner side 36A of the bent portion 36 is provided between an upper surface of the linear portion 37 extending in the front-rear direction X of the vehicle and an outer circumferential surface of the linear portion 35 extending in the up-down direction Z of the vehicle, the outer circumferential surface facing toward the linear portion 37. As shown in FIG. 3, a straight line L1 extending from the bent inner side 36A in the radial direction of the metal pipe 32 extends in a direction perpendicular to the width direction Y of the vehicle. Accordingly, the two electric wires 20 that are arranged side by side in the width direction Y of the vehicle in the internal space 32X of the bent portion 36 do not overlap along the straight line L1 extending from bent inner side 36A in the radial direction of the metal pipe 32. That is, the two electric wires 20 in the bent portion 36 are positioned side by side relative to the bent inner side 36A of the bent portion 36. In other words, in the present embodiment, as shown in FIG. 6, the arrangement direction of the plurality of electric wires 20 is restricted by the restricting members 40A and 40B such that the two electric wires 20 are positioned side by side relative to the bent inner side 36A in the internal space 32X of the bent portion 36. FIG. 3 shows a state in which the outer circumferential surfaces of the plurality of electric wires 20 in the bent portion 36 are spaced apart from the inner circumferential surface of the metal pipe 32, but the outer circumferential surfaces of the plurality of electric wires 20 in the bent portion 36 may be individually in contact with the inner circumferential surface of the metal pipe 32.

Next, a method for producing the wire harness 10 will be described.

First, in a step shown in FIG. 7(a), a plurality of (two in this example) electric wires 20 and a plurality of (two in this example) restricting members 40A and 40B are prepared. Next, the two electric wires 20 are passed through the housing space 41X of the plurality of restricting members 40A and 40B. At this time, although not shown in the diagram, the tape 50 is wound around the two electric wires 20 drawn out from the housing space 41X together with each of the holding pieces 43 of the restricting members 40A and 40B as shown in FIG. 5 so as to cause the two electric wires 20 to be held by the holding pieces 43 (the restricting members 40A and 40B). In this step, the major axis directions of the housing spaces 41X of the two restricting members 40A and 40B are set so as to extend in the same direction. For example, the major axis direction of the housing space 41X of the restricting member 40A and the major axis direction of the housing space 41X of the restricting member 40 are set so as to extend in the up-down direction Z of the vehicle. At this time, in each housing space 41X, the arrangement direction of the two electric wires 20 is restricted to the major axis direction of the housing space 41X. Accordingly, the two electric wires 20 in this step are arranged side by side in the up-down direction Z of the vehicle.

Next, in a step shown in FIG. 7(b), the restricting member 40B is rotated 90 degrees in the circumferential direction. In doing so, the housing space 41X of the restricting member 40B is rotated such that the major axis direction of the housing space 41X of the restricting member 40B extends in the width direction Y of the vehicle. At this time, in the housing space 41X, the arrangement direction of the two electric wires 20 is restricted to the major axis direction of the housing space 41X. Accordingly, when the restricting member 40B is rotated 90 degrees in the circumferential direction, in the housing space 41X of the restricting member 40B, the two electric wires 20 are arranged side by side in the width direction Y of the vehicle. As a result, the two electric wires 20 are twisted between the restricting member 40A and the restricting member 40B such that the arrangement direction of the two electric wires 20 is changed from the up-down direction Z of the vehicle to the width direction Y of the vehicle.

Next, in the step shown in FIG. 7(c), the two electric wires 20 twisted as shown in FIG. 7(b) are passed through a metal pipe 32. At this time, the protruding portions 42 of the restricting members 40A and 40B are fitted into predetermined groove portions 32Y of the metal pipe 32. As a result of the protruding portions 42 being fitted into the groove portions 32Y, the positions of the restricting members 40A and 40B in the circumferential direction of the metal pipe 32 can be fixed. After that, the metal pipe 32 is subjected to bending processing so as to form a bent portion 36 as shown in FIG. 6 in the metal pipe 32 at a position between the restricting member 40A and the restricting member 40B. Due to the bending processing, as shown in FIG. 6, the electric wires 20 that are passed through the metal pipe 32 are also bent. At this time, the two electric wires 20 that are passed through the bent portion 36 are positioned side by side relative to the bent inner side 36A of the bent portion 36. During the bending processing, the protruding portions 42 of the restricting members 40A and 40B are fitted into the groove portions 32Y of the metal pipe 32, and it is therefore possible to prevent the restricting members 40A and 40B from rotating in the circumferential direction. Furthermore, the two electric wires 20 are held by the holding pieces 43 of the restricting members 40A and 40B during the bending processing (see FIG. 5), and it is therefore possible to prevent the restricting members 40A and 40B from being displaced in the lengthwise direction of the electric wires 20.

Next, advantageous effects of the present embodiment will be described.

(1) A wire harness 10 of the present embodiment includes: a cylindrical metal pipe 32 that collectively houses a plurality of electric wires 20; and a restricting member 40 that is provided within the metal pipe 32, the restricting member 40 including a housing space 41X through which the plurality of electric wires 20 are passed through and that is shaped and sized to be capable of restricting an arrangement direction of the plurality of electric wires 20 to a specific direction. Also, a plurality of groove portions 32Y are formed on an inner circumferential surface of the metal pipe 32 at a predetermined spacing in a circumferential direction of the metal pipe 32, and a protruding portion 42 that is fitted into one of the groove portions 32Y is formed in an outer circumferential surface of the restricting member 40. With this configuration, by adjusting a fitting position at which the protruding portion 42 of the restricting member 40 is fitted into one of the plurality of groove portions 32Y of the metal pipe 32, the arrangement direction of the electric wires 20 that can be restricted by the restricting member 40 can be set to a desired direction. Accordingly, the arrangement direction of the electric wires 20 within the metal pipe 32 can be adjusted to a desired direction. It is therefore possible to easily adjust the arrangement direction of the electric wires 20 such that the plurality of electric wires 20 are positioned side by side relative to the bent inner side 36A of the bent portion 36. As a result, it is possible to prevent the plurality of electric wires 20 from overlapping and coming into contact with an inner circumferential surface of the bent inner side 36A, and thus the thickness of the insulation coating 22 of each of the electric wires 20 can be prevented from being reduced. Accordingly, a reduction in the insulation reliability of the electric wires 20 can be preferably prevented.

(2) Also, the protruding portion 42 of the restricting member 40 is fitted into one of the groove portions 32Y of the metal pipe 32, and it is therefore possible to prevent the restricting member 40 from rotating in the circumferential direction of the metal pipe 32 in the internal space 32X of the metal pipe 32. With this configuration, a positional offset of the restricting member 40 in the circumferential direction can be preferably prevented. Accordingly, the arrangement direction of the plurality of electric wires 20 can be preferably kept to a desired direction.

(3) A holding piece 43 that extends in a direction in which the plurality of electric wires 20 drawn out from the housing space 41X extend is formed on an end face of the restricting member 40. Furthermore, tape 50 is wound around the plurality of electric wires 20 together with the holding piece 43 so as to cause the plurality of electric wires 20 to be held by the holding piece 43. With this configuration, a positional offset of the restricting member 40 in the lengthwise direction of the plurality of electric wires 20 can be preferably prevented.

(4) The housing space 41X is configured to have a flat horizontal cross section. Furthermore, the housing space 41X is sized to be capable of collectively housing the plurality of electric wires 20 and restricting the arrangement direction of the plurality of electric wires 20 to only one direction. With this configuration, a plurality of electric wires 20 can be collectively passed through one housing space 41X, and thus ease of attaching the restricting member 40 to the plurality of electric wires 20 can be improved. Also, the arrangement direction of the plurality of electric wires 20 can be restricted to only one direction, and thus the arrangement direction of the electric wires 20 in the internal space 32X of the metal pipe 32 can be easily adjusted to a desired direction.

(5) The restricting member 40 is not provided in the bent portion 36 of the metal pipe 32, and is provided only in the linear portions 35 and 37 of the metal pipe 32. With this configuration, the occurrence of a problem in which the metal pipe 32 is unlikely to be bent as a result of the restricting member 40 being provided can be prevented.

(6) The problem of the conventional wire harness shown in FIG. 10 where the thickness of the insulation coating 91 of an electric wire 90 is reduced becomes noticeable when the hard metal pipe 80 is used as the protective tube for housing the electric wires 90. In contrast, in the wire harness 10 of the present embodiment, the restricting member 40 is provided in the internal space 32X of the metal pipe 32, and the arrangement direction of the plurality of electric wires 20 is adjusted by the restricting member 40. With this configuration, it is possible to prevent the plurality of electric wires 20 from overlapping and coming into contact with the inner circumferential surface of the hard metal pipe 32, and thus the occurrence of the problem where the thickness of the insulation coating 22 of the electric wire 20 is reduced can be preferably prevented.

### Other Embodiments

The embodiment given above can be carried out by making modifications as described below. The embodiment given above and variations, which will be given below, may be combined and carried out provided they don't technically contradict each other.

There is no particular limitation on the number of groove portions 32Y of the embodiment given above.

In the embodiment given above, the groove portions 32Y are formed over the entire inner circumferential surface of the metal pipe 32 in the circumferential direction of the metal pipe 32. However, for example, the groove portions 32Y may be formed only in a partial region of the inner circumferential surface of the metal pipe 32 in the circumferential direction of the metal pipe 32.

For example, as shown in FIG. 8, the groove portions 32Y may be formed only in a half-region of the inner circumferential surface of the metal pipe 32 in the circumferential direction of the metal pipe 32. In the metal pipe 32 shown in FIG. 8, the groove portions 32Y are formed only in an upper half region of the inner circumferential surface of the metal pipe 32. In the present variation, five groove portions 32Y are formed in the inner circumferential surface of the metal pipe 32.

In the embodiment given above, the plurality of groove portions 32Y are formed in the inner circumferential surface of the metal pipe 32 equidistantly in the circumferential direction of the metal pipe 32, but there is no particular limitation on the positions of the groove portions 32Y. For example, there is no particular limitation on the positions of the plurality of groove portions 32Y as long as they are formed on the inner circumferential surface of the metal pipe 32 at a predetermined spacing in the circumferential direction of the metal pipe 32.

In the embodiment given above, the protruding portions 42 are formed extending over the entire length of the main body portion 41 in the lengthwise direction of the main body portion 41, but the configuration is not limited thereto. For example, the protruding portions 42 may be formed partially in a portion of the main body portion 41 in the lengthwise direction of the main body portion 41.

There is no particular limitation on the number of protruding portions 42 of the embodiment given above. For example, there is no particular limitation on the number of protruding portions 42 as long as the number of protruding portions 42 is less than or equal to the number of groove portions 32Y of the metal pipe 32. For example, in the embodiment given above, the metal pipe 32 includes eight groove portions 32Y, and thus the number of protruding portions 42 can be set to 1 to 8. In the variation shown in FIG. 8, the metal pipe 32 includes five groove portions 32Y, and thus the number of protruding portions 42 can be set to 1 to 5. Furthermore, in the variation shown in FIG. 8, one protruding portion 42 is formed on the outer circumferential surface of the restricting member 40.

In the embodiment given above, the protruding portions 42 is provided extending along an extension line of the major axis of the housing space 41X. However, there is no particular limitation on the position of the protruding portions 42. For example, the protruding portions 42 may be provided extending along an extension line of the minor axis of the housing space 41X.

In the embodiment given above, two protruding portions 42 are provided at positions approximately 180 degrees apart from each other in the circumferential direction of the main body portion 41. However, there is no particular limitation on the positions of the protruding portions 42. For example, two protruding portions 42 may be provided at positions approximately 90 degrees apart from each other in the circumferential direction of the main body portion 41.

In the embodiment given above, the housing space 41X is configured to have an oval horizontal cross section, but the configuration is not limited thereto. For example, the horizontal cross section of the housing space 41X may have a circular shape, an elliptical shape, or a quadrangular shape.

The restricting member 40 of the embodiment given above is configured to include a housing space 41X that collectively houses a plurality of electric wires 20, but the configuration is not limited thereto. For example, the restricting member 40 may be configured to include a plurality of housing spaces in each of which one of the plurality of electric wires 20 is individually housed. The electric wires 20 may be press-fitted into the housing spaces in one-to-one correspondence. In this case, the electric wires 20 can be fixed to the restricting member 40 as a result of the electric wires 20 being press-fitted into the housing spaces, and thus the holding piece 43 of the restricting member 40 and the tape 50 can be omitted.

There is no particular limitation on the position of the holding piece 43 of the embodiment given above.

In the embodiment given above, the tape 50 is used as a specific example of the fixing member for fixing the plurality of electric wires 20 to the holding piece 43, but the configuration is not limited thereto. For example, instead of the tape 50, a cable tie or a crimping ring made of resin or metal, or the like may be used as the fixing member.

In the embodiment given above, the metal pipe 32 is configured to have a cylindrical shape, but the configuration is not limited thereto. The metal pipe 32 may be configured to have, for example, a quadrangular cylindrical shape, an elongated cylindrical shape, or an elliptic cylindrical shape. Even in this case, the groove portions 32Y are formed in the inner circumferential surface of the metal pipe 32.

In the embodiment given above, for example, the metal pipe 32 is bent into a two-dimensional shape, but the configuration is not limited thereto. For example, the metal pipe 32 may be bent into a three-dimensional shape.

In the embodiment given above, the external member 30 that includes corrugated tubes 31 and 33 and a metal pipe 32 is used as a specific example. The configuration is not limited thereto, and, for example, the external member 30 may be configured without including the corrugated tube 31 or the corrugated tubes 31 and 33, or in other words, may be configured so as to include only the metal pipe 32. Also, the corrugated tubes 31 and 33 and the metal pipe 32 may be replaced with other external members. For example, the metal pipe 32 may be replaced with a resin pipe. That is, as the protective tube, a resin pipe may be used as a specific example. The resin pipe in this case is configured to be harder than, for example, the insulation coatings 22 of the electric wires 20.

In the embodiment given above, unshielded electric wires are used as a specific example of the electric wires 20. However, shielded electric wires that have an electromagnetic shielding structure may be used as a specific example of the electric wires 20.

In the embodiment given above, two electric wires 20 are passed through the external member 30. However, there is no particular limitation on the number of electric wires 20, and the number of electric wires 20 can be changed according to the specifications of the vehicle. For example, the number of electric wires that are passed through the external member 30 may be one, or three or more. For example, low-voltage electric wires that connect a low-voltage battery and various types of low-voltage devices (for example, a lamp, a car stereo, and the like) may be added as the electric wires that are passed through the external member 30. Alternatively, only low-voltage electric wires may be used.

The positional relationship between the inverter 11 and the high-voltage battery 12 in the vehicle is not limited to that described in the embodiment given above, and may be changed as appropriate according to the configuration of the vehicle.

In the embodiment given above, the inverter 11 and the high-voltage battery 12 are used as the electric devices that are connected by the wire harness 10, but the configuration is not limited thereto. For example, the wire harness 10 may be applied to an electric wire that connects the inverter 11 and a motor for driving wheels. That is, the wire harness 10 is applicable to anything that can electrically connect electric devices that are mounted on a vehicle.

In some implementation examples of the present disclosure, the restricting member 40 may be disposed at an intermediate portion of the protective tube 32 in the lengthwise direction of the protective tube 32 that is opposite to opposing opening edges of the protective tube 32, and the restricting member 40 disposed at the intermediate portion of the protective tube 32 may be configured such that it does not come into contact or engage with the opening edges of the protective tube 32.

In some implementation examples of the present disclosure, when the protective tube 32 is viewed in a cross section, a portion of the outer circumferential surface of the restricting member 40 may be spaced apart from the inner circumferential surface of the protective tube 32, and a portion of the inner circumferential surface of the restricting member 40 may be spaced apart from the outer circumferential surfaces of the electric wires 20. For example, when the protective tube 32 is viewed in a cross section, an empty space or gap that allows a gas to flow therethrough may be defined between the protective tube 32 and the restricting member 40 and/or between the restricting member 40 and the electric wires 20.

In some implementation examples of the present disclosure, the protective tube 32 can include a bent portion 36. The wire harness 10 may include: a first restricting member 40A that is disposed in the protective tube 32 at a position spaced apart from the bent portion 36 of the protective tube 32 in a first axis direction; and a second restricting member 40B that is disposed in the protective tube 32 at a position spaced apart from the bent portion 36 of the protective tube 32 in a second axis direction. The bent portion 36 is located between the first restricting member 40A and the second restricting member 40B, and a continuous empty space that does not include a restricting member may continuously extend along the electric wires 20 between the first restricting member 40A and the second restricting member 40B.

In some implementation examples of the present disclosure, when the housing space 41X of the restricting member 40 is viewed in a cross section, the housing space 41X of the restricting member 40 may be a through hole that has an anisotropic shape such as a rectangular shape, and the anisotropic-shaped through hole (41X) of the restricting member 40 may be configured to bundle the plurality of electric wires 20 into an anisotropic-shaped bundle.

In some implementation examples of the present disclosure, the housing space 41X of the restricting member 40 may be configured to loosely house the anisotropic-shaped bundle of the plurality of electric wires 20. For example, the housing space 41X may allow the anisotropic-shaped bundle of the plurality of electric wires 20 to move in the radial direction within the housing space 41X, with the bundle maintaining its anisotropic shape.

In some implementation examples of the present disclosure, the anisotropic-shaped bundle of the plurality of electric wires 20 may be restricted or forcibly oriented at a position in the first axis direction by the first restricting member 40A so as to have a first rotation angle relative to a cross section of the protective tube 32 (FIG. 2). The anisotropic-shaped bundle of the plurality of electric wires 20 may be restricted or forcibly oriented at a position in the second axis direction by the second restricting member 40B so as to have a second rotation angle relative to a cross section of the protective tube 32 (FIG. 4). The first rotation angle (FIG. 2) and the second rotation angle (FIG. 4) may have a predetermined phase difference, for example, a phase difference of 90 degrees.

In some implementation examples of the present disclosure, the plurality of electric wires 20 may include a twisted portion at a position in a third axis direction that is between the position in the first axis direction and the position in the second axis direction and excludes the bent portion 36 (FIG. 6).

In some implementation examples of the present disclosure, the plurality of electric wires 20 may be disposed in state floating from the inner circumferential surface of the protective tube 32 at least in the bent portion 36.

In some implementation examples of the present disclosure, the inner circumferential surface of the protective tube 32 may include a plurality of rails that extend over the entire length of the protective tube 32 and define a plurality of groove portions 32Y between the plurality of rails The restricting member 40 may include a cylindrical main body portion 41 and a protruding portion 42 that radially protrudes outward from the cylindrical main body portion 41. The cylindrical main body portion 41 may be configured to come into contact with and be supported by radial inner surfaces of the protective tube 32 that are top surfaces of the plurality of rails. The protruding portion 42 may be configured to engage with one groove portion 32Y selected from among the plurality of groove portions 32Y of the protective tube 32 such that the restricting member 40 maintains a desired rotation angle relative to the protective tube 32.

### LIST OF REFERENCE NUMERALS

V Vehicle

10 Wire harness

11 Inverter

12 High-voltage battery

20 Electric wire

21 Core wire

22 Insulation coating

30 External member

31, 33 Corrugated tube

32 Metal pipe (protective tube)

32X Internal space

32Y Groove portion

35, 37 Linear portion

36 Bent portion

36A Bent inner side

40, 40A, 40B Restricting member

Main body portion

41X Housing space

42 Protruding portion

43 Holding piece

50 Tape (fixing member)

1. A wire harness comprising:
a plurality of electric wires;
a cylindrical protective tube that collectively houses the plurality of electric wires;
a restricting member that is provided within the protective tube and includes a housing space through which the plurality of electric wires are passed and that is shaped and sized to restrict an arrangement direction of the plurality of electric wires to a specific direction;
a plurality of grooves that are formed in an inner circumferential surface of the protective tube at a predetermined spacing in a circumferential direction of the protective tube; and
a protrusion that is formed on an outer circumferential surface of the restricting member and is fitted into one groove of the plurality of grooves.

2. The wire harness according to claim 1, wherein:
a holding piece that protrudes in a direction in which the plurality of electric wires that are drawn out from the housing space extend is formed on an end face of the restricting member, and
a fixing member that fixes the plurality of electric wires to the holding piece is provided.

3. The wire harness according to claim 1, wherein:
the housing space has a flat horizontal cross section, and
the housing space is sized to allow the plurality of electric wires to be collectively passed through and restrict the arrangement direction of the plurality of electric wires to only one direction.

4. The wire harness according to claim 1, wherein:
the protective tube includes a linear portion and a bent portion, and
the restricting member is not provided in the bent portion, and is provided only in the linear portion.

5. The wire harness according to claim 4, wherein:
the linear portion includes two linear portions,
the restricting member is provided in each of the two linear portions that are provided across the bent portion, the two linear portions being provided in the protective tube, and
the restricting members provided in the two linear portions restrict the arrangement direction of the plurality of electric wires such that the plurality of electric wires are positioned side by side relative to a bent inner side of the bent portion.

6. The wire harness according to claim 1, wherein:
the protective tube is a metal pipe, and
the plurality of electric wires are unshielded electric wires that do not have an electromagnetic shielding structure.
